(19) United States
(12) Patent Application Publication
(10) Pub. No.: US 2025/0087088 A1
(43) Pub. Date: Mar. 13, 2025

(54) SIGNAL CONTROL SYSTEM, SIGNAL CONTROL METHOD, AND RECORDING MEDIUM

(71) Applicant: NEC Corporation, Minato-ku, Tokyo (JP)

(72) Inventor: Nobuyuki TOZAWA, Tokyo (JP)

(73) Assignee: NEC Corporation, Minato-ku, Tokyo (JP)

(21) Appl. No.: 18/725,874

(22) PCT Filed: Jan. 24, 2022
(86) PCT No.: PCT/JP2022/002341

§ 371 Date: Jul. 1, 2024

(51) Int. Cl. G08G 1/07; G06V 20/52; G08G 1/005

(52) U.S. Cl. CPC G08G 1/07; G06V 20/52; G08G 1/005

(57) ABSTRACT

This signal control system comprises: a data acquisition unit that acquire determination data for determining whether or not to switch a control mode of a traffic light at an intersection to pedestrian-and-vehicle separation type signal control; and a signal control unit that switch the control mode of the traffic light at the intersection to the pedestrian/vehicle separation-type signal control for a predetermined period, when it is determined whether or not the current situation satisfies a predetermined switching condition on the basis of the determination

### TECHNICAL FIELD

The present invention relates to a signal control system, a signal control method, and a recording medium.

### BACKGROUND ART

As a measure to reduce pedestrian-and-vehicle accidents between vehicles and a pedestrians, a pedestrian-and-vehicle separating type signal control (including a diagonal crossing that allows pedestrians to diagonally cross an intersection) capable of temporally separating traffic flows of the pedestrians and the vehicles has attracted attention. One aspect regarding the pedestrian-and-vehicle separating type signal control is that traffic congestion will worsen because the movement of the vehicles is stopped for a certain period of time during a signal control cycle.

On the other hand, the pedestrian-and-vehicle separating type signal control may help to smooth the traffic in some intersections. For example, in an intersection where the amount of pedestrians at a crosswalk is large and a vehicle that turns right or left during the time of green indication is forced to stop due to pedestrian crossing, the pedestrian-and-vehicle separating type signal control is considered to be more advantageous.

PTL 1 discloses a moving person monitoring device capable of controlling a vehicle traffic light and a pedestrian traffic light more efficiently by examining a situation and the number of pedestrians at the road intersection.

### CITATION LIST

### Patent Literature

PTL 1: JP 11-275562 A

### SUMMARY OF INVENTION

### Technical Problem

In the moving person monitoring device of PTL 1, the pedestrian traffic light and the vehicle traffic light are controlled based on the number of pedestrians waiting for crossing near the pedestrian traffic light (hereinafter, “a pedestrian or the like waiting for a traffic light”) and the waiting time. For this reason, when there are many pedestrians waiting at a traffic light, there is a possibility that a right or left turn of the vehicle is hindered and a traffic jam occurs.

On the other hand, there is a possibility that the pedestrian-and-vehicle separating type signal control can reduce the pedestrian-and-vehicle accidents between the vehicle and the pedestrian, but the passable time of the vehicle decreases by the time the pedestrian can cross, and thus there is a demand for suppressing the time for performing the pedestrian-and-vehicle separating type signal control.

An object of the present invention is to provide a signal control system, a signal control method, and a recording medium that can contribute to both reducing pedestrian-and-vehicle accidents and smoothing road traffic.

### Solution to Problem

According to a first aspect, there is provided a signal control system including a data acquisition means for acquiring determination data for determining whether to switch a control mode of a traffic light at an intersection to a pedestrian-and-vehicle separating signal control, and a signal control means for switching the control mode of the traffic light at the intersection to the pedestrian-and-vehicle separating type signal control for a predetermined period of time in a case where it is determined that the current situation satisfies a predetermined switching condition based on the determination data.

According to a second aspect, there is provided a signal control system including an operation schedule acquisition means for acquiring an operation schedule of a passenger-carrying vehicle at a station or a stop near an intersection, a creation means for creating a signal control schedule for switching a control mode of a traffic light at the intersection to a pedestrian-and-vehicle separating type signal control for a predetermined period of time based on the operation schedule, and a signal control means for switching the control mode of the traffic light at the intersection based on the signal control schedule.

According to a third aspect, there is provided a signal control method including acquiring determination data for determining whether to switch a control mode of a traffic light at an intersection to a pedestrian-and-vehicle separating type signal control, determining whether the determination data satisfies a predetermined switching condition, and switching the control mode of the traffic light at the intersection to the pedestrian-and-vehicle separating type signal control for a predetermined period of time in a case where it is determined that the determination data satisfies the predetermined switching condition.

According to a fourth aspect, there is provided a signal control method including acquiring an operation schedule of a passenger-carrying vehicle at a station or a stop near an intersection, creating, based on the operation schedule, a signal control schedule for switching a control mode of a traffic light at the intersection to a pedestrian-and-vehicle separating type signal control for a predetermined period of time, and switching the control mode of the traffic light at the intersection based on the signal control schedule.

According to a fifth aspect, there is provided a computer-readable recording medium storing a program for causing a computer to execute a process including acquiring determination data for determining whether to switch a control mode of a traffic light at an intersection to a pedestrian-and-vehicle separating type signal control, determining whether the determination data satisfies a predetermined switching condition, and switching the control mode of the traffic light at the intersection to the pedestrian-and-vehicle separating type signal control for a predetermined period of time in a case where it is determined that the determination data satisfies the predetermined switching condition.

According to a sixth aspect, there is provided a computer-readable recording medium storing a program for causing a computer to execute a process including acquiring an operation schedule of a passenger-carrying vehicle at a station or a stop near an intersection, creating, based on the operation schedule, a signal control schedule for switching a control mode of a traffic light at the intersection to a pedestrian-and-vehicle separating type signal control for a predetermined period of time, and switching the control mode of the traffic light at the intersection based on the signal control schedule.

### Advantageous Effects of Invention

According to the present invention, a signal control system, a signal control method, and a recording medium that can contribute to both reducing pedestrian-and-vehicle accidents and smoothing road traffic are provided.

### BRIEF DESCRIPTION OF DRAWINGS

FIG. 1 is a diagram illustrating a configuration according to an example embodiment of the present invention.

FIG. 2 is a diagram for explaining an operation according to an example embodiment of the present invention.

FIG. 3 is another diagram for explaining an operation according to an example embodiment of the present invention.

FIG. 4 is a diagram for explaining basic data for calculating a first evaluation value used in an example embodiment of the present invention.

FIG. 5 is a flowchart illustrating an operation according to an example embodiment of the present invention.

FIG. 6 is a diagram illustrating a configuration according to a first example embodiment of the present invention.

FIG. 7 is a diagram illustrating an example of switching condition information stored in a switching condition storage unit of a signal control system according to an example embodiment of the present invention.

FIG. 8 is a diagram illustrating an example of a change in display content of a display board by the signal control system according to the first example embodiment of the present invention.

FIG. 9 is a flowchart illustrating an operation of the signal control system according to the first example embodiment of the present invention.

FIG. 10 illustrates an example of a signal cycle diagram switched by the signal control system according to the first example embodiment of the present invention.

FIG. 11 is a diagram illustrating a configuration according to a second example embodiment of the present invention.

FIG. 12 illustrates an example of a signal control schedule created by a signal control system according to the second example embodiment of the present invention.

FIG. 13 is a flowchart illustrating an operation of the signal control system according to the second example embodiment of the present invention.

FIG. 14 is a diagram illustrating a configuration according to a third example embodiment of the present invention.

FIG. 15 is a diagram illustrating an example of a display form of an in-vehicle terminal by a signal control system according to the third example embodiment of the present invention.

FIG. 16 is a diagram illustrating another example of the display form of the in-vehicle terminal by the signal control system according to the third example embodiment of the present invention.

FIG. 17 illustrates an example of a signal cycle diagram switched by a signal control system according to a fourth example embodiment of the present invention.

FIG. 18 is a signal cycle diagram for explaining the fourth example embodiment of the present invention.

FIG. 19 illustrates an example of the signal cycle diagram switched by the signal control system according to the fourth example embodiment of the present invention.

FIG. 20 is a diagram illustrating a configuration of a computer constituting a signal control system according to the present invention.

### EXAMPLE EMBODIMENT

First, an outline of an example embodiment of the present invention will be described with reference to the drawings. The reference numerals in the drawings attached to this outline are attached to each element for convenience as an example for assisting understanding, and are not intended to limit the present invention to the illustrated aspects. In addition, connection lines between blocks in the drawings and the like referred to in the following description include both bidirectional and unidirectional. The unidirectional arrow schematically indicates a flow of a main signal (data), and does not exclude bidirectionality. The program is executed via a computer device, and the computer device includes, for example, a processor, a storage device, an input device, a communication interface, and a display device as necessary. The computer device is made to be able to communicate with a device (including a computer) inside or outside the device via a communication interface regardless of wired or wireless. Although there are ports and interfaces at connection points of input and output of each block in the drawing, illustration thereof is omitted.

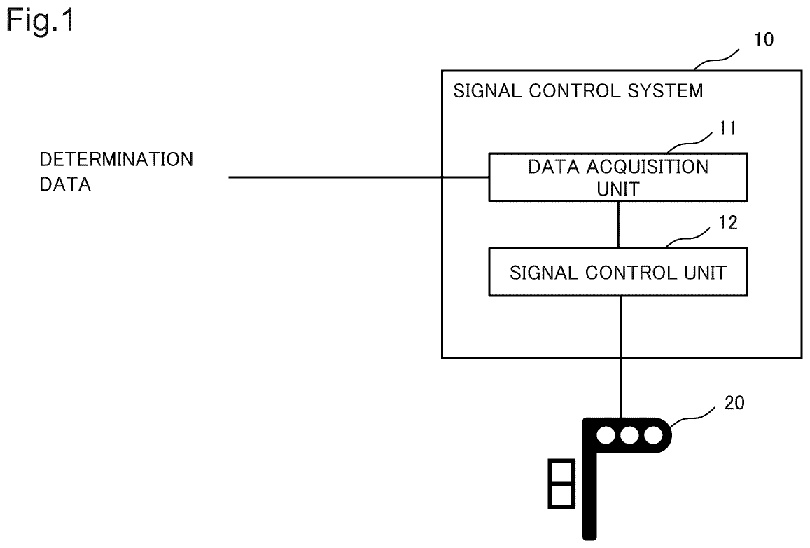

In an example embodiment of the present invention, as illustrated in FIG. 1, the present invention can be achieved by a signal control system 10 including a data acquisition means 11 and a signal control means 12.

More specifically, the data acquisition means 11 acquires determination data for determining whether to switch a control mode of a traffic light at an intersection to a pedestrian-and-vehicle separating type signal control. As the determination data, position information of a self-driving vehicle or a passenger-carrying vehicle (trains, buses, trams, etc.) with respect to an intersection can be used. As the determination data, a position notification from the self-driving vehicle or the passenger-carrying vehicle or data transmitted from a sensor that detects entry of the self-driving vehicle or the passenger-carrying vehicle can be used. An image captured by a camera capable of capturing a vehicle approaching in the direction of the intersection can be used as the determination data.

Then, the signal control means 12 determines whether the current situation satisfies a predetermined switching condition based on the determination data. In a case where it is determined that the predetermined switching condition is satisfied as a result of the determination, the signal control means 12 switches the control mode of a traffic light 20 at the intersection to the pedestrian-and-vehicle separating type signal control for a predetermined period of time. As the switching condition, a condition that the self-driving vehicle or the passenger-carrying vehicle has approached the intersection can be used.

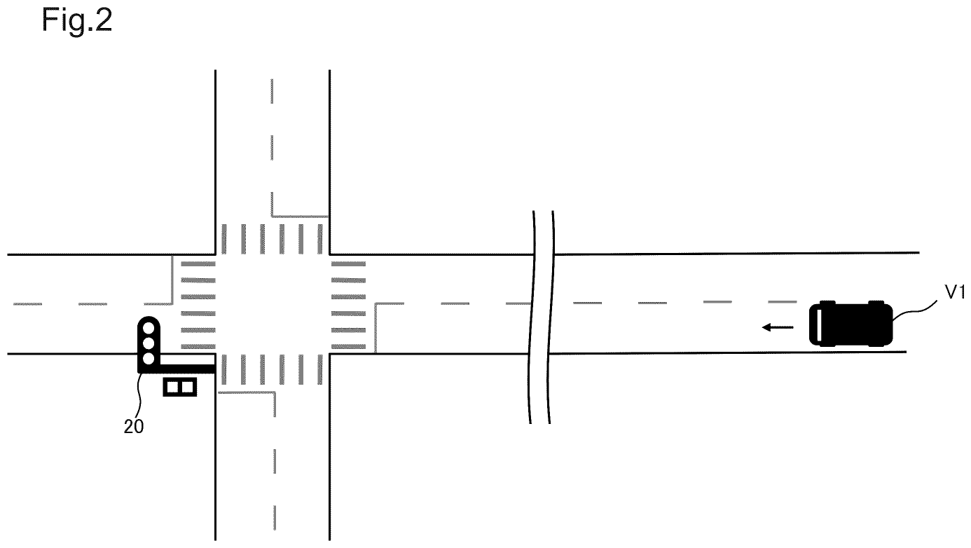

For example, as illustrated in FIG. 2, when a self-driving vehicle VI (or a passenger-carrying vehicle) is approaching an intersection, the signal control system 10 switches the control mode of the traffic light 20 at the intersection to the pedestrian-and-vehicle separating type signal control for a predetermined period of time. With this configuration, it is possible to temporally separate traffic flows of the pedestrians and the vehicles when the self-driving vehicle VI (or the passenger-carrying vehicle) passes through the intersection, and to reduce an accident between pedestrians.

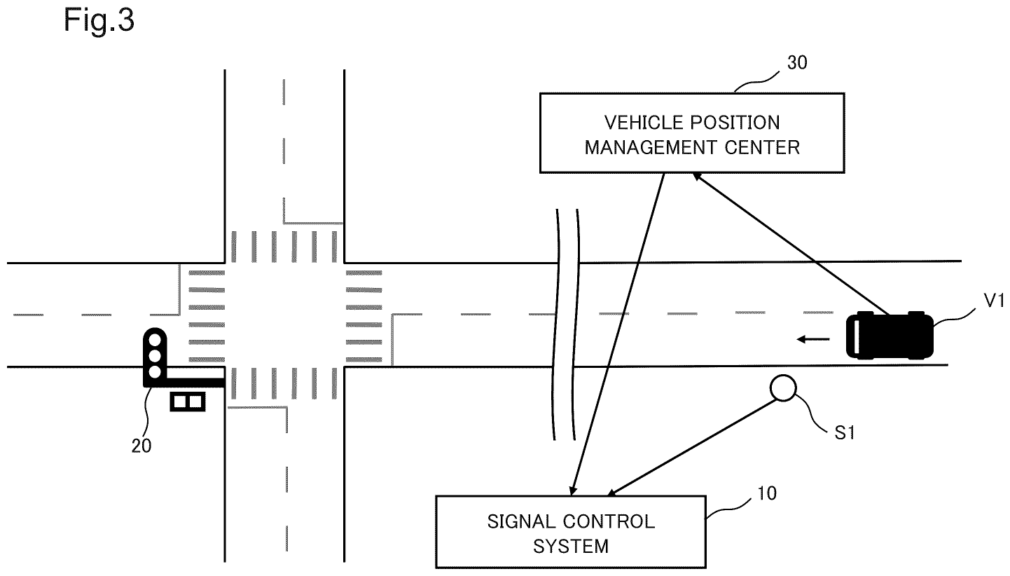

As a mechanism for detecting the approach of the self-driving vehicle VI (or passenger-carrying vehicle) to the intersection by the signal control system 10, a method of identifying (detecting) the self-driving vehicle VI (or passenger-carrying vehicle) by the sensor S1 installed near the road and notifying the signal control system 10 can be adopted as illustrated in FIG. 3. The self-driving vehicle VI (or passenger-carrying vehicle) may transmit the position information to a vehicle position management center 30 of FIG. 3. In this case, the signal control system 10 may acquire the position information of the self-driving vehicle VI (or the passenger-carrying vehicle) from the vehicle position management center 30. When an image captured by a camera is used as the determination data, the vehicle may be recognized as an object from the image, and the approach of the self-driving vehicle VI (or passenger-carrying vehicle) to the intersection may be detected. In order to facilitate identification of the self-driving vehicle VI, there may be attached a dedicated sign indicating that it is an automatic cloud ladder on the self-driving vehicle.

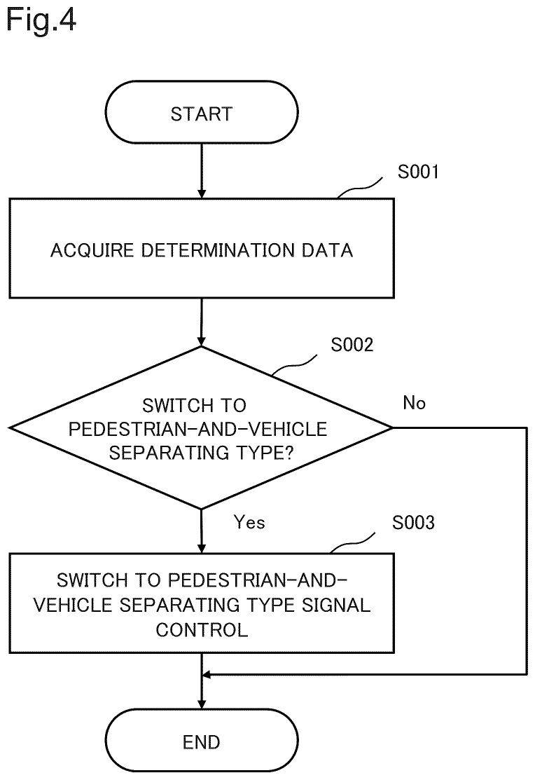

The signal control system 10 operates as illustrated in FIG. 4. First, the signal control system 10 acquires determination data for determining whether to switch the control mode of the traffic light at the intersection to the pedestrian-and-vehicle separating type signal control (step S001). Next, the signal control system 10 determines whether the current situation satisfies the predetermined switching condition based on the determination data (step S002). In a case where it is determined that the predetermined switching condition is satisfied (Yes in step S002), the signal control system 10 switches the control mode of the traffic light at the intersection to the pedestrian-and-vehicle separating type signal control for a predetermined period of time (step S003). In a case where it is determined in step S002 that the determination data does not satisfy the predetermined switching condition, the signal control system 10 maintains the previous signal control mode (No in step S002).

With this configuration, it is possible to temporally separate traffic flows of the pedestrians and the vehicles when the self-driving vehicle VI (or the passenger-carrying vehicle) passes through the intersection, and to reduce an accident between pedestrians. The reason is that a configuration is adopted in which the control mode of the traffic light is switched to the pedestrian-and-vehicle separating type signal control in response to the approach of the self-driving vehicle VI (or the passenger-carrying vehicle). When the self-driving vehicle VI (or the passenger-carrying vehicle) does not exist nearby, the signal control system 10 controls the traffic light in a control mode other than the pedestrian-and-vehicle separating type signal control, in such a way that the smooth road traffic is also achieved.

The example embodiment of the present invention is not limited to the above example, and various types of information can be used as the determination data. For example, it is also possible to adopt a configuration in which time information is used as the determination data, and the approach of the self-driving vehicle VI (or passenger-carrying vehicle) is determined with reference to an operation schedule of the self-driving vehicle VI (or passenger-carrying vehicle).

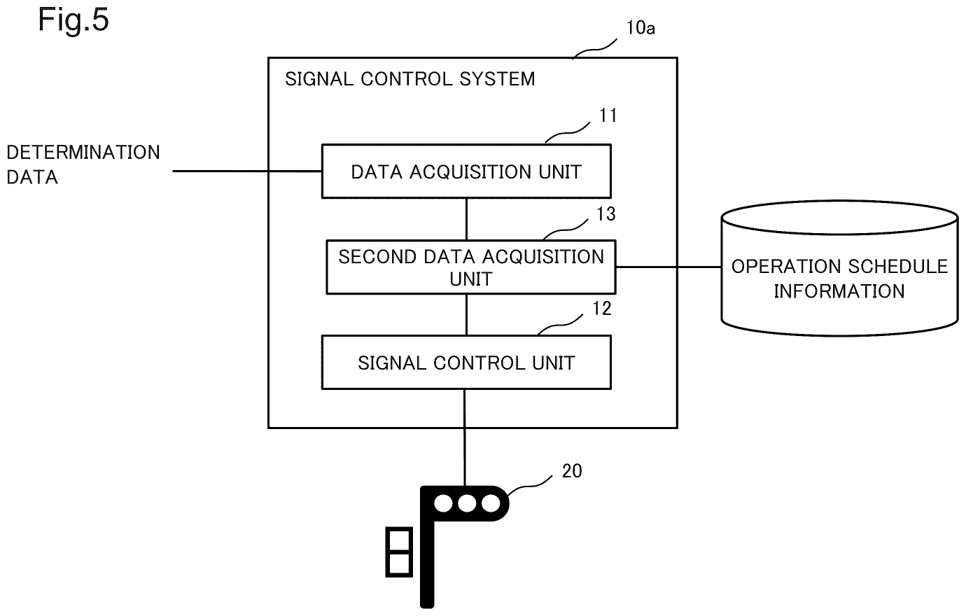

In another example embodiment, as illustrated in FIG. 5, a signal control system 10a may include a second data acquisition means 13 that acquires an operation schedule from an external device. As the external device, a timetable server of various transportation facilities or a timetable server that provides timetables of each company upon user's request can be used.

Even with such a configuration using a timetable, it is possible to temporally separate the traffic flows of pedestrians and vehicles when the self-driving vehicle VI (or passenger-carrying vehicle) passes through the intersection, and reduce accidents between pedestrians and vehicles. The reason is that a configuration is adopted in which the control mode of the traffic light is switched to the pedestrian-and-vehicle separating type signal control in response to the approach of the self-driving vehicle VI (or the passenger-carrying vehicle). When the self-driving vehicle VI (or the passenger-carrying vehicle) does not exist nearby, the signal control system 10a controls the traffic light in a control mode other than the pedestrian-and-vehicle separating type signal control, in such a way that the smooth road traffic is also achieved.

### First Example Embodiment

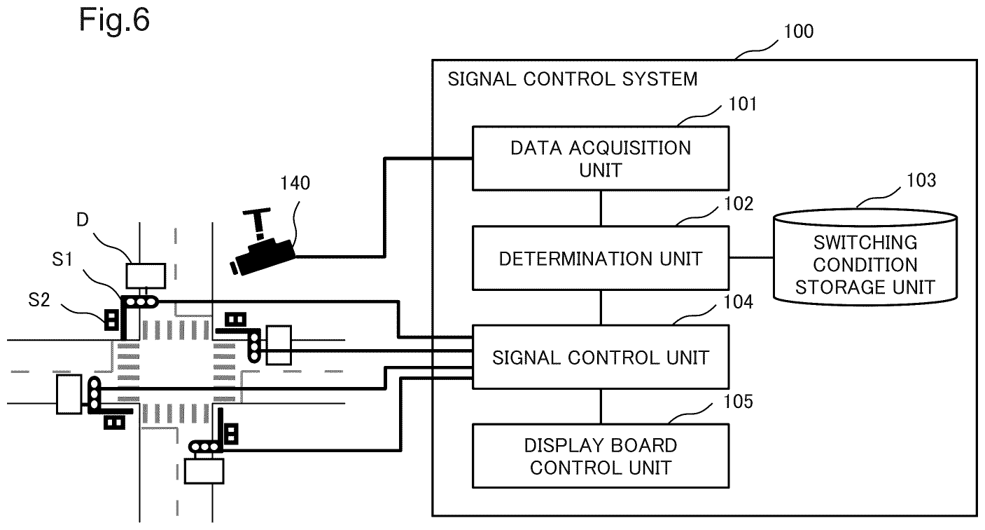

Next, a first example embodiment in which a signal control system controls a display board attached to a traffic light at an intersection will be described in detail with reference to the drawings. FIG. 6 is a diagram illustrating a configuration according to the first example embodiment of the present invention. Referring to FIG. 6, a configuration including an intersection where a vehicle traffic light S1, a pedestrian traffic light S2, and a display board D are installed, a signal control system 100 that controls the intersection, and a camera 140 that captures an image of the intersection is illustrated.

One or more cameras 140 are installed at suitable positions for capturing an image of a vehicle approaching the intersection illustrated in FIG. 6.

The signal control system 100 includes a data acquisition means 101, a determination means 102, a switching condition storage means 103, a signal control means 104, and a display board control means 105. The signal control system 100 may be a signal control device disposed at each of one or more intersections or a device functioning as a multi-access edge computing (MEC) server. The signal control system 100 may be a device arranged in a traffic management system that controls traffic lights and signal control devices at a plurality of intersections.

The data acquisition means 101 detects a specific vehicle approaching an intersection from an image form the camera 140 and transmits the information to the determination means 102. As a mechanism for detecting the specific vehicle by the data acquisition means 101, an object recognition technology using artificial intelligence (AI) or the like can be used.

The determination means 102 refers to the switching condition stored in the switching condition storage means 103 to determine whether to switch the control mode of the vehicle traffic light S1 and the pedestrian traffic light S2 at the intersection to the pedestrian-and-vehicle separating type signal control. In a case where it is determined to switch to the pedestrian-and-vehicle separating type signal control, the determination means 102 instructs the signal control means 104 to switch to the pedestrian-and-vehicle separating type signal control.

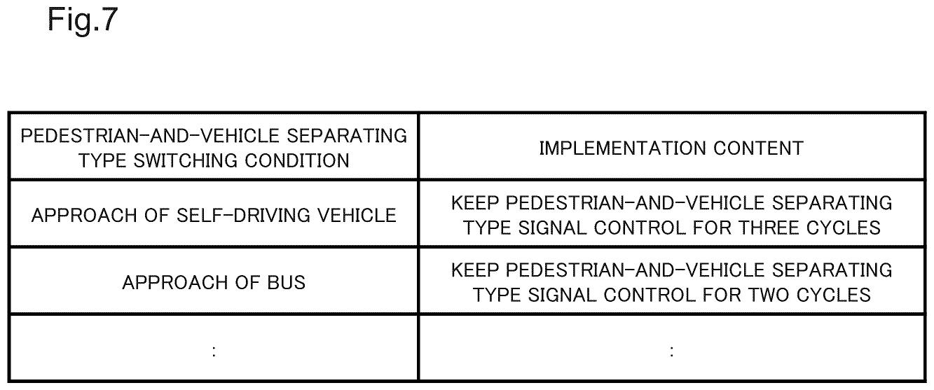

FIG. 7 is an example of the switching condition stored in the switching condition storage means 103. In the pedestrian-and-vehicle separation type switching condition field, conditions for starting the pedestrian-and-vehicle separating type signal control such as approach of a self-driving vehicle and approach of a bus are set. In the implementation content field, the implementation content for each of the pedestrian-and-vehicle separation switching conditions such as “keep the pedestrian-and-vehicle separating type signal control for three cycles” and “keep the pedestrian-and-vehicle separating type signal control for two cycles” is defined. For example, when the approach of a self-driving vehicle is detected by the data acquisition means 101, the “keep pedestrian-and-vehicle separating type signal control for 3 cycles” is selected. The description form of the switching condition is not limited to the form illustrated in FIG. 7. For example, in a case where the system for specifying the self-driving vehicle by the license plate information is adopted, the license plate information of the self-driving vehicle is set as the switching condition. Instead of the condition of the approaching self-driving vehicle, a description using a position such as an arrival of the self-driving vehicle to Position A can also be adopted. Furthermore, in a case where the execution period of the pedestrian-and-vehicle separating type signal control is determined in advance, the implementation content field can be omitted. For example, in a case where it is determined to perform the pedestrian-and-vehicle separating type signal control for one cycle, only the switching condition may be defined in the switching condition storage means 103.

The signal control means 104 controls the vehicle traffic light S1 and the pedestrian traffic light S2 at the intersection according to an instruction from the determination means 102. Before switching the control mode of the vehicle traffic light S1 and the pedestrian traffic light S2, the signal control means 104 instructs the display board control means 105 about the content to be displayed on a display board D. According to the present example embodiment, the determination means 102 and the signal control means 104 are independent, but they may be integrated to function as one signal control means.

The display board control means 105 switches the display content of the display board D according to the content instructed from the signal control means 104.

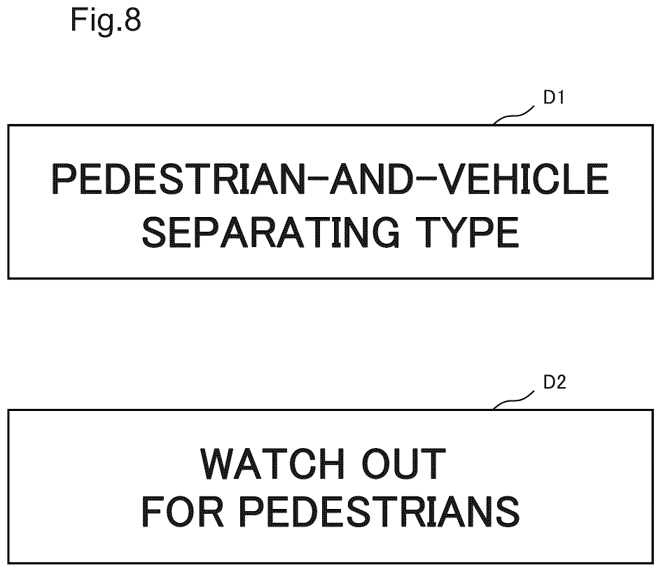

FIG. 8 is a diagram illustrating an example of a change in the display content of the display board D by the display board control means 105. For example, the display board control means 105 may display, on the display board D, the signal control method being executed by the traffic light at the intersection. In a case where the traffic lights at the intersection are operating in the pedestrian-and-vehicle separating type, the display board control means 105 displays “PEDESTRIAN-AND-VEHICLE SEPARATING TYPE” D1 on the display board D. On the other hand, in a case where all the signals at the intersection are operated by a method other than the pedestrian-and-vehicle separating type, the display board control means 105 displays a message to call attention to drivers, such as “WATCH OUT FOR PEDESTRIANS” D2, on the display board D. As the display board D, an electric-type display board using a light emitting diode (LED), a roll-type (mechanical) display board, or the like can be used. As the method of the display board when all the traffic lights at the intersection operate by a method other than the pedestrian-vehicle separating type, display control such as displaying the name of the intersection, displaying nothing, turning off the display, and the like may be performed in addition to displaying “Watch out for pedestrians”. Of course, a relevant signal control method such as “time-difference signal” or a “sensor-activated signal” may be displayed.

In addition to the display of the signal control method in execution described above, the display board control means 105 may display, on the display board, the remaining time until the signal indication in the signal control method in execution is switched using a counter or a figure. The display of the remaining time can take, for example, a form of presenting the remaining time until the signal is switched by counter display of an inverse formula, or a form of presenting the remaining time until the signal is switched by counter display of displaying the elapsed time together with the value of the split. Instead of the display of the remaining time or the like by the numerical value described above, a mode of presenting the time at which the signal is switched next by increasing or decreasing the gauge can also be adopted. In this manner, a driver of a vehicle V can recognize that the traffic light at the intersection passing through is the traffic light that operates in the pedestrian-and-vehicle separating type and the time until the color of the indication changes next.

As described above, by displaying the control mode applied to the traffic light at the intersection, vehicle drivers and pedestrians can predict the behavior of the traffic light at the intersection, and needless accidents with crossing pedestrians and the like can be prevented.

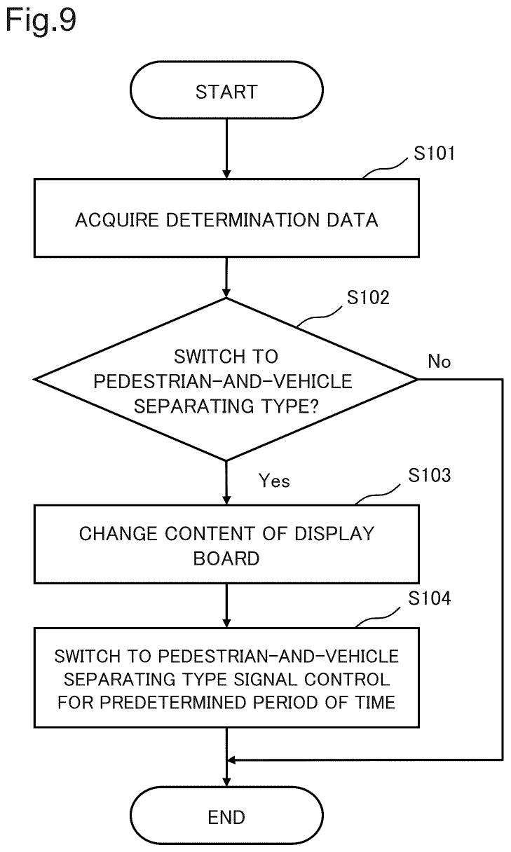

Next, an operation of the present example embodiment will be described in detail with reference to the drawings. FIG. 9 is a flowchart illustrating an operation of the signal control system according to the first example embodiment of the present invention. Referring to FIG. 9, first, the signal control system 100 acquires an image from the camera 140 as determination data (step S101).

Next, the signal control system 100 analyzes the determination data and determines whether it is needed to switch to the pedestrian-and-vehicle separating type signal control (step S102). Here, in a case where it is determined not to switch to the pedestrian-and-vehicle separating type signal control (No in step S102), the signal control system 100 maintains the current control mode.

On the other hand, in a case where it is determined to switch to the pedestrian-and-vehicle separating type signal control (Yes in step S102), the signal control system 100 first changes the display content of the display board D (step S103).

Then, the signal control system 100 performs signal control by the pedestrian-and-vehicle separating type signal control for a predetermined period of time (step S104).

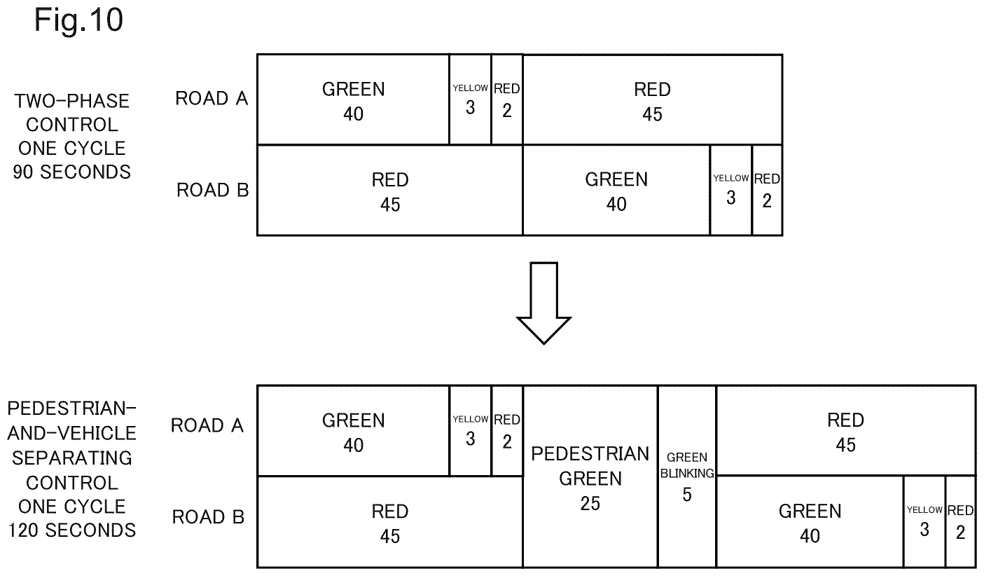

As a result, the signal cycle of the traffic light at the intersection is switched from the contents in the upper part of FIG. 10 (two-phase method) to the contents in the lower part of FIG. 10. In FIG. 10, the indication contents of pedestrian traffic light S2 is omitted. As a result, at the intersection, a time is provided during which all the display contents of the pedestrian traffic light S2 turn green during one cycle. In the example of FIG. 10, the signal cycle is switched to a signal cycle in which a green light indication time of 25 seconds and a green light blinking time of 5 seconds are inserted. As described above, when the approach of a self-driving vehicle or a bus is set as the switching condition, this helps to reduce pedestrian-and-vehicle accidents caused by the intersection traffic of these vehicles. When these vehicles are not present, the traffic light is controlled in a control mode other than the pedestrian-and-vehicle separating type signal control, and thus, smooth road traffic is also achieved.

According to the above example embodiment, the approach of a self-driving vehicle and a bus is exemplified as the switching condition, but the switching condition is not limited thereto. For example, the signal control system 100 may acquire an image of the vicinity of the intersection from the camera 140 as the determination data, and perform the pedestrian-and-vehicle separating type signal control for a predetermined period of time based on the number of pedestrians appearing in the image and the attribute of the pedestrians. Specifically, it is also possible to adopt a switching condition in which the pedestrian-and-vehicle separating type signal control is performed for a predetermined period of time in response to an approach of a traffic-vulnerable people such as a child or an elderly person to an intersection.

A switching condition related to a predetermined number or more of approaching pedestrians who may cross the intersection may be set, and a switching condition in which the pedestrian-and-vehicle separating type signal control may be performed only according to need.

### Second Example Embodiment

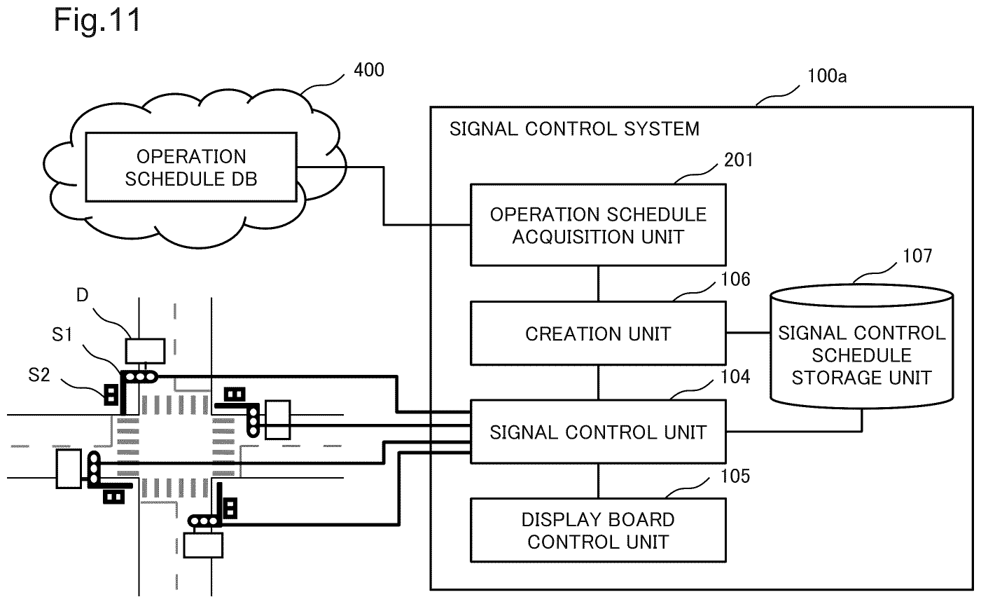

Next, a second example embodiment in which a signal control system creates a signal control schedule based on a vehicle operation schedule will be described in detail with reference to the drawings. FIG. 11 is a diagram illustrating a configuration according to the second example embodiment of the present invention. A difference from the configuration of the first example embodiment illustrated in FIG. 6 is that a signal control system 100a creates a signal control schedule based on operation status data instead of detecting approaching vehicles. According to this configuration, the present invention can be implemented even at an intersection where no camera is installed.

Specifically, the signal control system 100a includes an operation schedule acquisition means 201, a creation means 106, a signal control means 204, a display board control means 105, and a signal control schedule storage means 107.

The operation schedule database (operation schedule DB) 400 is a database that provides train or bus operation schedules. As such a database, a database that can provide operation schedule information using a predetermined application programming interface (API) can be used. As the operation schedule DB 400, a timetable server or the like disclosed on the Internet or a cloud base can also be used. The “operation schedule” is also referred to as a “railway timetable” or a “railway diagram” in our country.

The operation schedule acquisition means 201 acquires the operation schedule of a passenger-carrying vehicle at the station or the stop near the operation schedule intersection from the operation schedule DB 400, and transmits the operation schedule to the creation means 106.

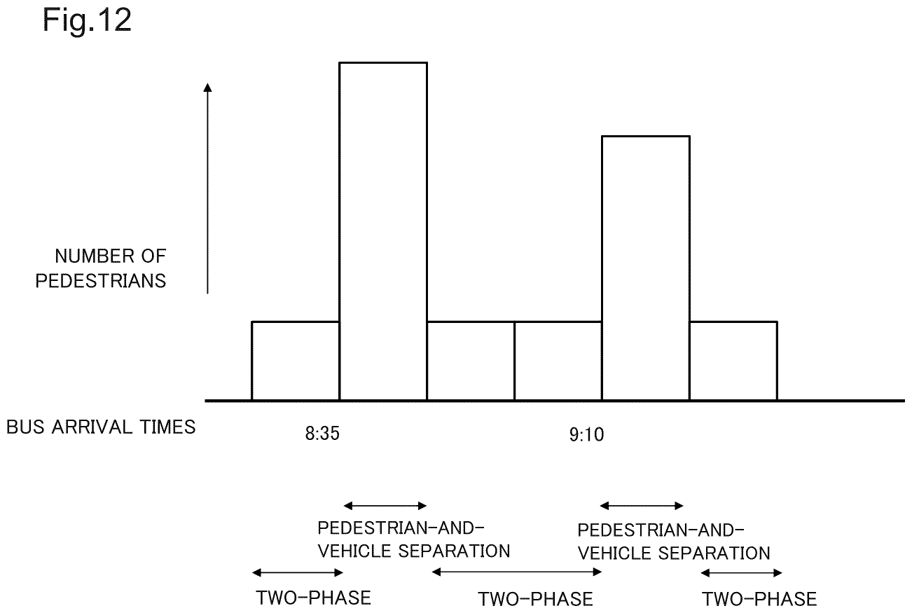

The creation means 106 creates, based on the operation schedule, a signal control schedule for switching the control mode of the traffic light at the intersection to the pedestrian-and-vehicle separating type signal control for a predetermined period of time. FIG. 12 illustrates an example of the signal control schedule created by the creation means 106. In FIG. 12, 8:35 a.m. and 9:10 a.m. indicate times on the operation schedule when a passenger-carrying vehicle arrives at a station or a bus stop near the intersection. In this case, as illustrated in the lower part of FIG. 12, the creation means 106 creates a signal control schedule for executing the pedestrian-and-vehicle separating type signal control for a predetermined period of time after the arrival of the passenger-carrying vehicle. The creation means 106 stores the created operation schedule in the signal control schedule storage means 107.

The signal control means 204 controls the vehicle traffic light S1 and the pedestrian traffic light S2 at the intersection according to the signal control schedule stored in the signal control schedule storage means 107. Before changing the signal control method, the signal control means 204 instructs the display board control means 105 on the contents to be displayed on the display board D.

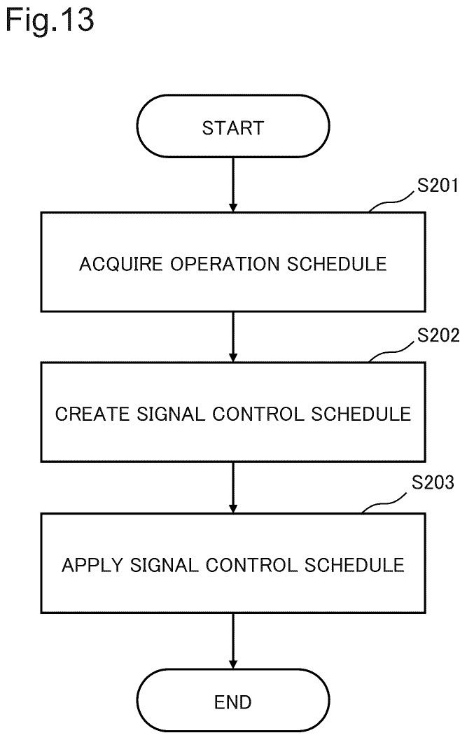

Next, an operation of the present example embodiment will be described in detail with reference to the drawings. FIG. 13 is a flowchart illustrating an operation of the signal control system 100a according to the second example embodiment of the present invention. First, the signal control system 100a acquires an operation schedule of a passenger-carrying vehicle at a station or a stop near the intersection (step S201). Next, the signal control system 10 creates a signal control schedule for performing the pedestrian-and-vehicle separating type signal control at the intersection based on the operation schedule (step S202).

Next, the signal control system 100a applies the created signal control schedule and starts the control of the vehicle traffic light S1, the pedestrian traffic light S2, and the display board D (step S203).

According to the second example embodiment operating as described above, it is possible to perform the pedestrian-and-vehicle separating type signal control at an appropriate timing even at an intersection where a camera is not installed or where it is structurally difficult to install a camera. The present example embodiment can also be implemented at an intersection where a camera is installed. In this case, after creating the signal control schedule based on the operation schedule, the signal control system 100a can perform modification such as detecting a delay of the passenger-carrying vehicle or the like based on the image from the camera 140 and correcting the signal control schedule.

### Third Example Embodiment

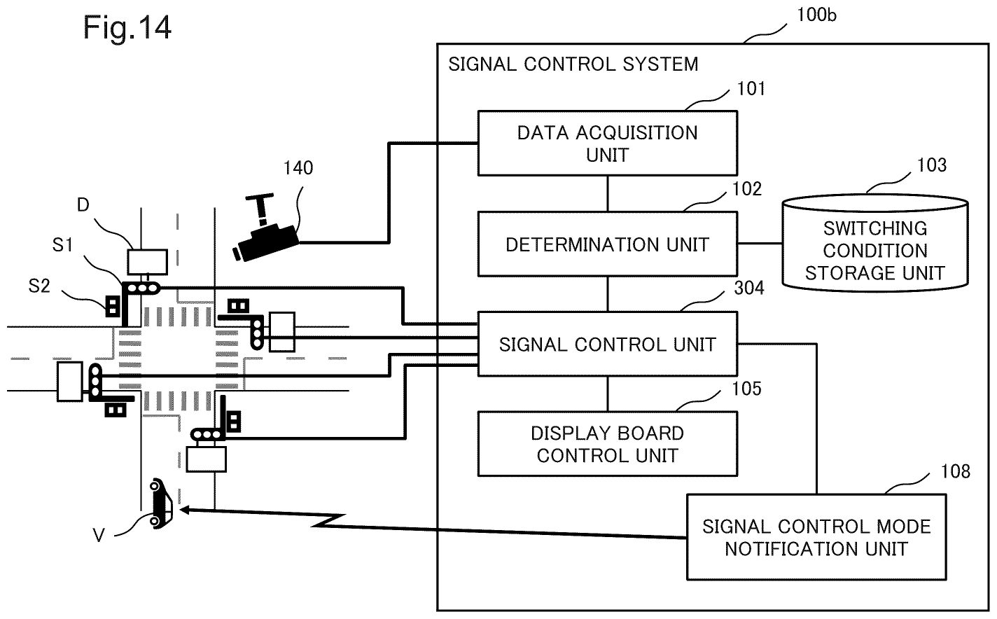

Next, a third example embodiment in which a function of notifying a vehicle approaching an intersection is added to a signal control system will be described in detail with reference to the drawings. FIG. 14 is a diagram illustrating a configuration according to the third example embodiment of the present invention. The difference from the configuration of the first example embodiment illustrated in FIG. 6 is that a signal control mode notification means 108 is added to a signal control system 100b, and a signal control means 304 controls the signal control mode notification means 108. Since the other configurations are similar to those of the first example embodiment, differences thereof will be mainly described below.

The signal control means 304 controls the vehicle traffic light S1 and the pedestrian traffic light S2 at the intersection according to an instruction of the determination means 102. The signal control means 304 instructs the signal control mode notification means 108 to notify, to a vehicle approaching the intersection, the signal control mode or the like being executed by the traffic light at the intersection.

In response to the instruction from the signal control means 304, the signal control mode notification means 108 notifies, to a vehicle approaching the intersection, a signal control mode or the like being executed by the traffic light at the intersection. As a method in which the signal control mode notification means 108 notifies, to the vehicle approaching the intersection, the signal control mode and the like, broadcast via a roadside machine or a mobile communication network can be used. In a more desirable mode, the signal control mode notification means 108 can include, in the notification, information on a target intersection (traffic light), a range of a position of the vehicle on a reception side, identification information (ID) of a vehicle read by a roadside sensor, and the like. With such a configuration, the vehicle on the reception side can determine whether the information notified from the signal control system 100b is for the vehicle itself with reference to the position or identification information of the vehicle.

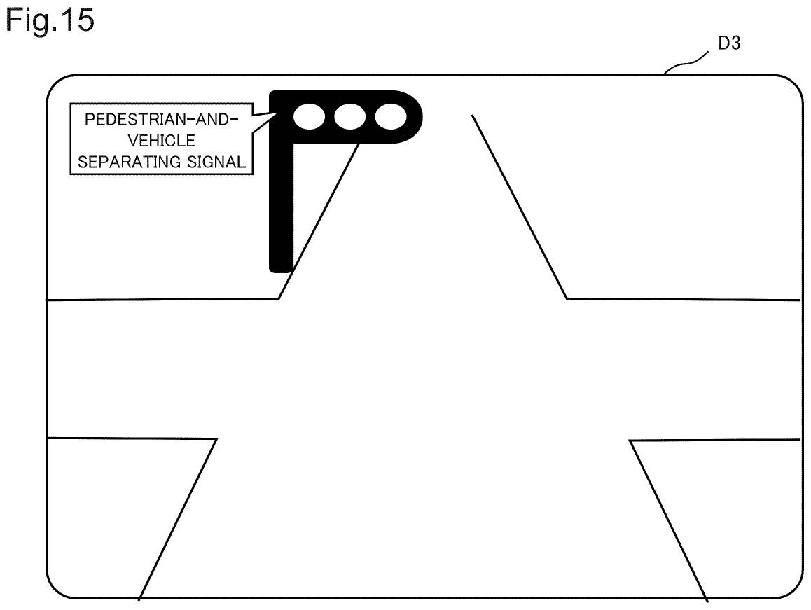

FIG. 15 is a diagram illustrating an example of a display form of the vehicle on an in-vehicle terminal by the signal control system 100b of the present example embodiment. In the example of FIG. 15, a display of “PEDESTRIAN-AND-VEHICLE SEPARATING SIGNAL” is added to the traffic light on a display screen D3 of the in-vehicle terminal of the vehicle V. In other words, a display of a waiting time until the next phase by the current signal control method is added. With such configuration, the driver of the vehicle V can recognize that the traffic light at the intersection through which the vehicle V is going to pass is a traffic light that performs the pedestrian-and-vehicle separating type. As a result, it is possible to prevent the vehicle V from starting with careless predictions after the end of the red indication.

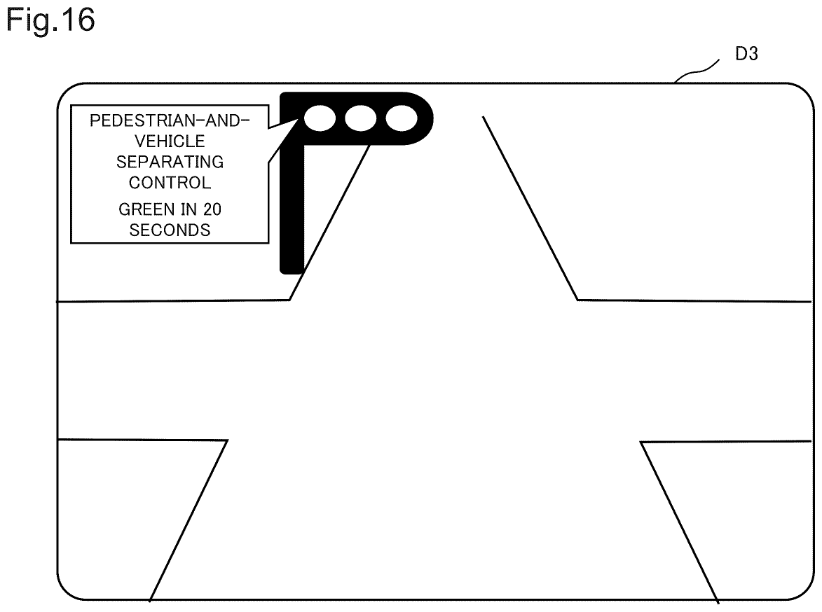

FIG. 16 is a diagram illustrating another example of the display form of the vehicle on the in-vehicle terminal by the signal control system 100b of the present example embodiment. In the present example of FIG. 16, the information that the traffic light is in the “pedestrian-and-vehicle separating type” and the display of the remaining time until the indication of the signal is switched are added to the traffic light on the display screen D3 of the in-vehicle terminal of the vehicle V. In this manner, a driver of a vehicle V can recognize that the traffic light at the intersection passing through is the traffic light that operates in the pedestrian-and-vehicle separating type and the time until the color of the indication changes next. As a result, it is possible to prevent the vehicle V from starting with careless predictions after the end of the red indication.

The display form by the in-vehicle terminal can be variously modified, and a form in which a head-up display projects and displays on a windshield can be adopted in addition to the display device installed in the vehicle. In addition to the display on various display devices, a notification of whether the “pedestrian-and-vehicle separating type” is adopted, the time until the signal changes or the like may be made by voice.

As described above, according to the present example embodiment, in addition to the display of the display board D, the information regarding the signal control mode can also be displayed on the in-vehicle terminal of the vehicle to notify the driver to call attention. The examples illustrated in FIGS. 15 and 16 are merely examples of the present example embodiment. For example, instead of displaying the text “GREEN IN 20 SECONDS” in FIG. 16, the time until the signal is switched may be presented by a counter or a figure. For example, it is possible to adopt a form in which the remaining time until the signal in the signal control method being executed is switched is presented by the counter display of the inverse formula, or a form in which the remaining time until the signal in the signal control method being executed is switched is presented by the counter display displaying the elapsed time together with the value of the split. Instead of the display of the remaining time or the like by the numerical value described above, a mode of presenting the time at which the signal is switched next by increasing or decreasing the gauge can also be adopted.

In the present example embodiment, it has been described that the signal control system 100b notifies the in-vehicle terminal of the vehicle of the information regarding the signal control mode, but the signal control system 100b may provide the same information to the pedestrians. With such configuration, it is possible to prevent the pedestrian from starting to cross the crosswalk by misunderstanding.

### Fourth Example Embodiment

Next, a fourth example embodiment is to extend a so-called all-red-light period during a signal cycle before and after switching will be described in detail with reference to the drawings. Since the fourth example embodiment can be achieved by the same configuration as the first to third example embodiments, differences in operation will be mainly described below.

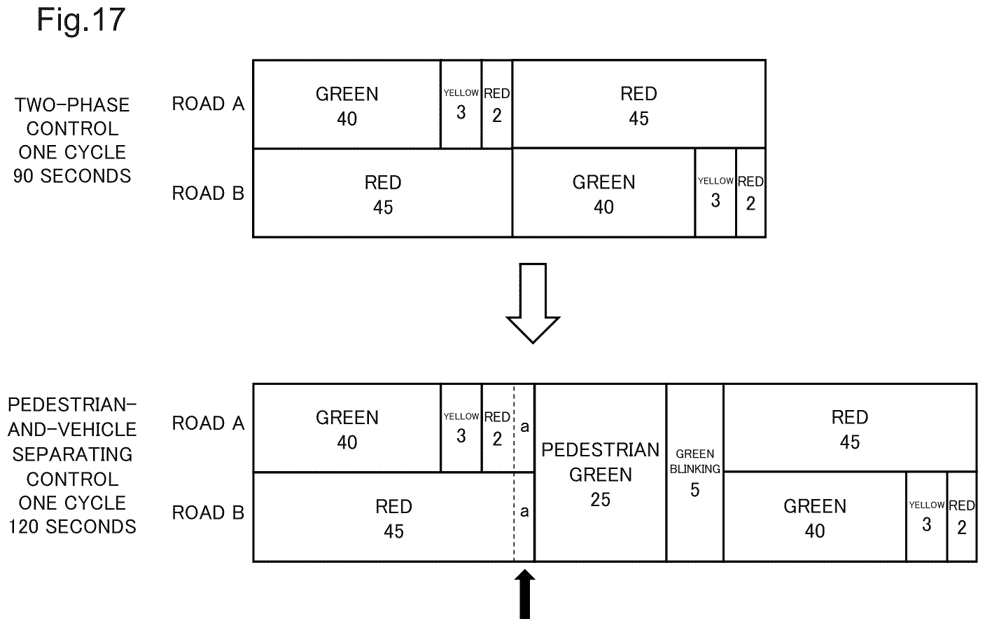

FIG. 17 is an example of a signal cycle diagram switched by the signal control system of the present example embodiment, and illustrates a signal cycle diagram before and after the switching from the two-phase method to the pedestrian-and-vehicle separating type. A difference from the signal cycle diagram of the first example embodiment illustrated in FIG. 10 is that the first all-red-light period immediately after switching from the two-phase method to the pedestrian-and-vehicle separating type is extended by “a” seconds. Normally, in the case of the two-phase control, when the signal of Road A changes from green, yellow, and then red, the signal of Road B turns green (see the upper part of FIG. 17). However, when the pedestrian-and-vehicle separating type is adopted, after the traffic light of Road A changes from green, yellow, and then red, all the pedestrian traffic lights S2 turn on green indication (see the lower part of FIG. 17). At that time, if the driver of the vehicle on Road B misunderstands that it is a two-phase method and does not stop or starts the vehicle, the vehicle intersects with the pedestrians.

Therefore, according to the present example embodiment, as described above, the first all-red-light period immediately after the switching from the two-phase method to the pedestrian-and-vehicle separating type is extended by “a” seconds. As a result, according to the present example embodiment, it is possible to urge the driver of the vehicle on Road B to stop, and it is possible to reduce the possibility of the occurrence of the intersecting with the pedestrians.

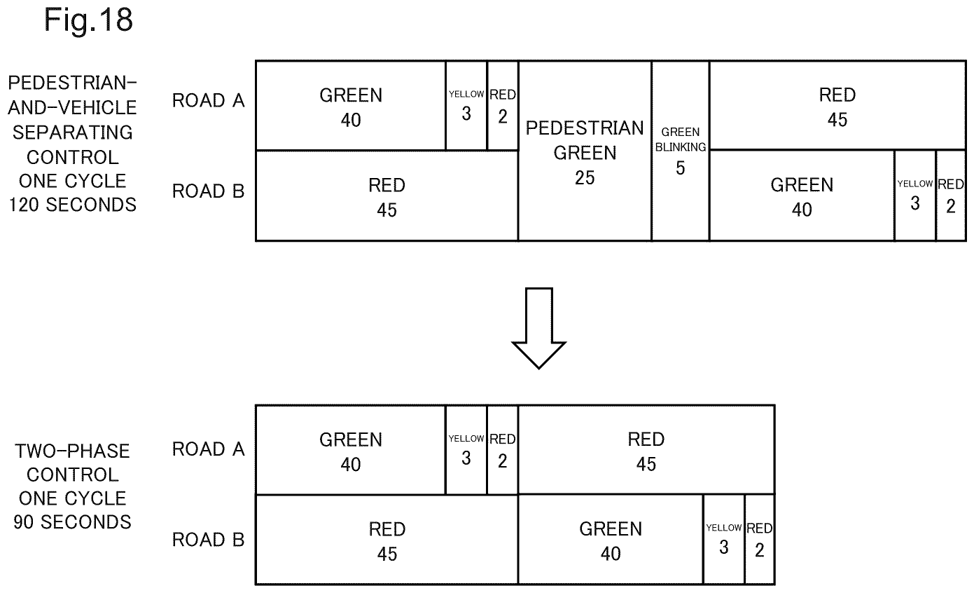

The same can occur in a case where the pedestrian-and-vehicle separating type is switched to the two-phase method. FIG. 18 is an example of a signal cycle diagram at the time of switching from the pedestrian-and-vehicle separating type to the two-phase method. Also in this case, after the traffic light of Road A changes from green, yellow, and then red, the time when all-green-light period of the pedestrian traffic lights S2 is skipped, and the traffic light of Road B changes to green indication. At that time, if a pedestrian misunderstands with the pedestrian-and-vehicle separating type and starts crossing the crosswalk, the pedestrian and the vehicle will intersect each other.

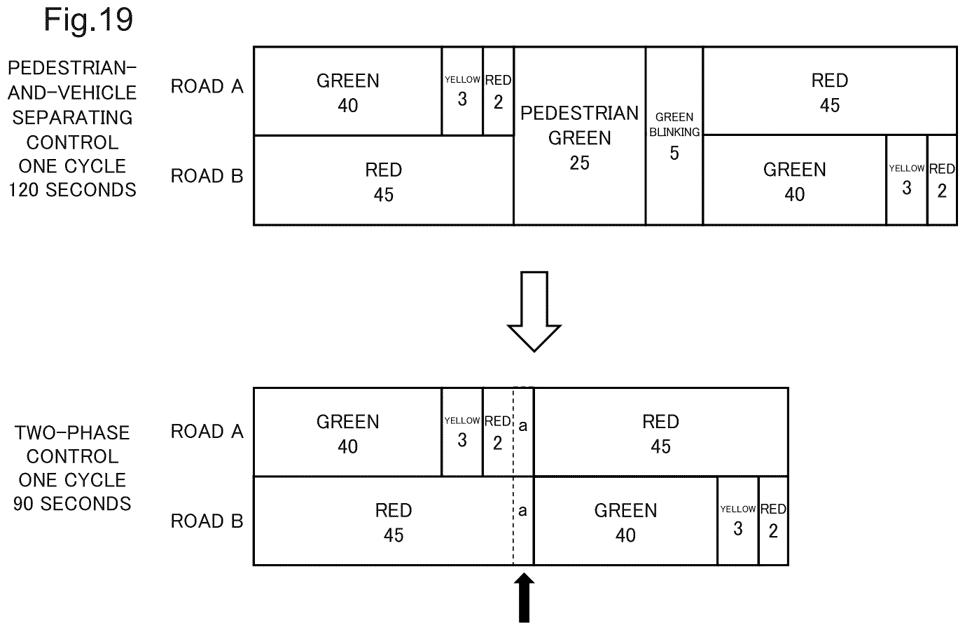

Therefore, in the present example embodiment, as illustrated in FIG. 19, the first all-red-light period immediately after the switching from the pedestrian-and-vehicle separating type to the two-phase method is extended by a predetermined time of “a” seconds. As a result, according to the present example embodiment, it is possible to urge the driver of the vehicle on Road B to stop, and the possibility of the occurrence of the intersecting with the pedestrians can be reduced.

In the above example, it has been described that the first all-red-light period immediately after the switching from the two-phase method to the pedestrian-and-vehicle separating type and the first all-red-light period immediately after the switching from the pedestrian-and-vehicle separating type to the two-phase method are extended, but the extension of the all-red-light period is not necessarily limited to once. If necessary, the signal control system 100 may repeat the above-described extension of the all-red-light period for a plurality of cycles.

Although the example embodiments of the present invention have been described above, the present invention is not limited to the above-described example embodiments, and further modifications, substitutions, and adjustments can be made without departing from the basic technical idea of the present invention. For example, the network configuration, the configuration of each element, and the representation form of data illustrated in the drawings are examples for assisting the understanding of the present invention, and are not limited to the configurations illustrated in the drawings.

For example, in the first to fourth example embodiments described above, it has been described that the signal control system 100 to 100b controls the signal, but a mode in which the signal control system 100 to 100b only creates a signal control schedule can also be adopted. In this case, it is possible to adopt a form in which the signal control system 100 to 100b provides a signal control schedule to another signal control device, and the another signal control device may control the traffic light.

In the first to fourth example embodiments described above, the signal control system 100 to 100b switches the signal control mode at one intersection. However, a configuration in which the signal control system 100 to 100b switches the signal control modes at a plurality of intersections can also be adopted.

In the first to fourth example embodiments described above, it has been described that a vehicle has a traffic regulation for traveling on the left side of the road, but the present invention can be similarly applied to a country having a traffic regulation for traveling on the right side of the road. In this case, the left and right in each of the above example embodiments are reversed.

### (Regarding Hardware Configuration)

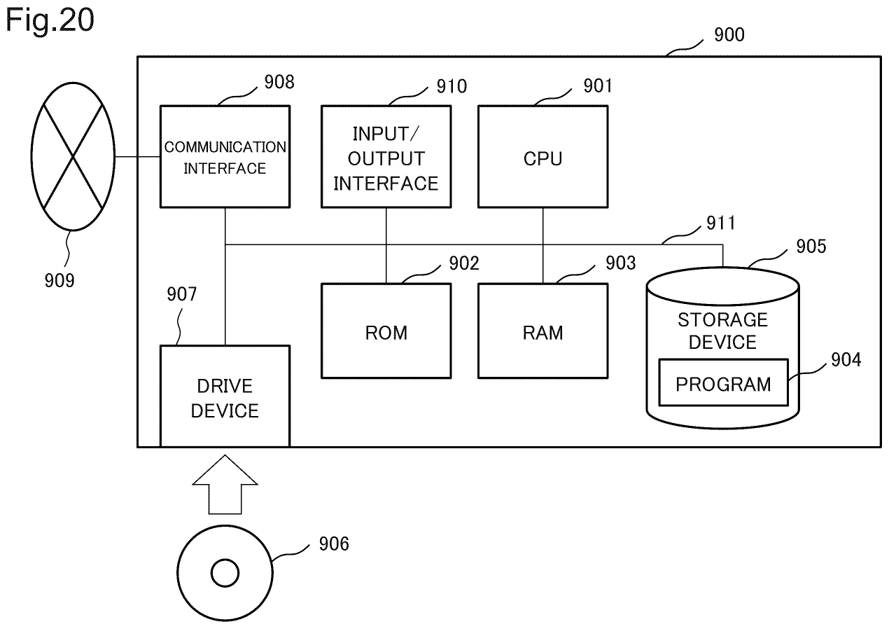

In each example embodiment of the present disclosure, each component of each device indicates a block of a functional unit. A part or all of each component of each device is achieved by, for example, an arbitrary combination of an information processing device 900 and a program as illustrated in FIG. 20. FIG. 20 is a block diagram illustrating an example of a hardware configuration of the information processing device 900 that achieves each component of each device. The information processing device 900 includes the following configuration as an example.
central processing unit (CPU) 901
read only memory (ROM) 902
random access memory (RAM) 903
program 904 loaded into RAM 903
storage device 905 storing program 904
drive device 907 that reads and writes in recording medium 906
communication interface 908 connected with communication network 909
input/output interface 910 for inputting and outputting data
bus 911 that connects components

Each component of each device in each example embodiment is achieved by the CPU 901 acquiring and executing the program 904 for achieving these functions. In other words, the CPU 901 of FIG. 20 may execute a data acquisition program and a signal schedule creation program to perform update processing of each calculation parameter held in the RAM 903, the storage device 905, or the like. The program 904 for achieving the function of each component of each device is stored in the storage device 905 or the ROM 902 in advance, for example, and is read by the CPU 901 as necessary. The program 904 may be supplied to the CPU 901 via the communication network 909, or may be stored in advance in the recording medium 906, and the drive device 907 may read the program and supply the program to the CPU 901.

In addition, the program 904 can display the processing result including the intermediate state for each stage via the display device as necessary, or can communicate with the outside via the communication interface. The program 904 can be recorded on a computer-readable (non-transitory) recording medium.

There are various modifications of the implementation method of each device. For example, each device may be achieved by an arbitrary combination of the information processing device 900 and the program for each component. A plurality of components included in each device may be achieved by an arbitrary combination of one information processing device 900 and a program. That is, each unit (processing means and function) of the signal control system described in the first to fourth example embodiments can be achieved by a computer program that causes a processor mounted in the device to execute each processing described above using hardware thereof.

Some or all of the components of each device are achieved by other general-purpose or dedicated circuits, processors, or the like, or a combination of those devices. These may be configured by a single chip or may be configured by a plurality of chips connected via a bus.

Some or all of the components of each device may be achieved by a combination of the above-described circuit or the like and a program.

In a case where some or all of the components of each device are achieved by a plurality of information processing devices, circuits, and the like, the plurality of information processing devices, circuits, and the like may be arranged in a centralized manner or in a distributed manner. For example, the information processing device, the circuit, and the like may be achieved in a manner of being connected to one another via a communication network, such as a client and server system or a cloud computing system.

Each of the above-described example embodiments is a suitable example embodiment of the present disclosure, and the scope of the present disclosure is not limited only to each of the above-described example embodiments. In other words, it is possible for those skilled in the art to make modifications and substitutions of the above-described example embodiments without departing from the gist of the present disclosure, and to construct a mode in which various modifications are made.

Some or all of the above example embodiments can also be described as the following supplementary notes, but are not limited to the following.

### [Supplementary Note 1]

A signal control system including:
a data acquisition means configured to acquire determination data for determining whether to switch a control mode of a traffic light at an intersection to a pedestrian-and-vehicle separating type signal control; and
a signal control means configured to switch the control mode of the traffic light at the intersection to the pedestrian-and-vehicle separating type signal control for a predetermined period of time in a case where it is determined that the current situation satisfies a predetermined switching condition based on the determination data.

### [Supplementary Note 2]

The determination data that the signal control system acquires may be data indicating a position of a self-driving vehicle or a passenger-carrying vehicle, and
the signal control means may switch the control mode of the traffic light at the intersection to the pedestrian-and-vehicle separating type signal control for a predetermined period of time in a case where the self-driving vehicle or the passenger-carrying vehicle approaches the intersection.

### [Supplementary Note 3]

The determination data that the signal control system acquires may be a position notification from the self-driving vehicle, or the passenger-carrying vehicle or data transmitted from a sensor that detects entry of the self-driving vehicle or the passenger-carrying vehicle.

### [Supplementary Note 4]

The determination data that the signal control system acquires may be an image of a vicinity of the intersection, and
the signal control means may switch the control mode of the traffic light at the intersection to the pedestrian-and-vehicle separating type signal control for a predetermined period of time based on the number or attributes of pedestrians appearing in the image.

### [Supplementary Note 5]

In the signal control system,
a second data acquisition means configured to acquire an operation schedule of the passenger-carrying vehicle at a station or a stop near the intersection may be further included, and
the signal control means may switch the control mode of the traffic light at the intersection to the pedestrian-and-vehicle separating type signal control for a predetermined period of time based on the time information acquired as the determination data and the operation schedule information of the passenger-carrying vehicle.

### [Supplementary Note 6]

A signal control system including:
an operation schedule acquisition means configured to acquire an operation schedule of a passenger-carrying vehicle at a station or a stop near an intersection;
a creation means configured to create a signal control schedule for switching a control mode of a traffic light at the intersection to a pedestrian-and-vehicle separating type signal control for a predetermined period of time based on the operation schedule; and
a signal control means configured to switch the control mode of the traffic light at the intersection based on the signal control schedule.

### [Supplementary Note 7]

The signal control system may further include
a means configured to change, according to the switching of the signal control, display contents of a display board that displays a signal control mode being executed at the traffic light of the intersection.

### [Supplementary Note 8]

The signal control system may cause the display board to display a counter or a figure indicating a waiting time until a next phase in the currently executed signal control mode.

### [Supplementary Note 9]

The signal control system may further include
a means configured to notify, to a vehicle near the intersection, the signal control mode being executed in the traffic light at the intersection.

### [Supplementary Note 10]

The signal control system may have a configuration in which
the vehicle is notified of a counter or a figure indicating a waiting time until the next phase in the currently executed signal control mode.

### [Supplementary Note 11]

The signal control system may have a configuration in which
after switching from a signal control other than the pedestrian-and-vehicle separating type signal control to the pedestrian-and-vehicle separating type signal control, the signal control for extending an all-red-light period in one cycle for a predetermined time is performed.

### [Supplementary Note 12]

A signal control method including:
acquiring determination data for determining whether to switch a control mode of a traffic light at an intersection to a pedestrian-and-vehicle separating type signal control;
determining whether the determination data satisfies a predetermined switching condition; and
switching the control mode of the traffic light at the intersection to the pedestrian-and-vehicle separating type signal control for a predetermined period of time in a case where it is determined that the determination data satisfies the predetermined switching condition.

### [Supplementary Note 13]

A signal control method including:
acquiring an operation schedule of a passenger-carrying vehicle at a station or a stop near an intersection;
creating, based on the operation schedule, a signal control schedule for switching a control mode of a traffic light at the intersection to a pedestrian-and-vehicle separating type signal control for a predetermined period of time; and
switching the control mode of the traffic light at the intersection based on the signal control schedule.

### [Supplementary Note 14]

A computer-readable recording medium storing a program for causing a computer to execute a process including:
acquiring determination data for determining whether to switch a control mode of a traffic light at an intersection to a pedestrian-and-vehicle separating type signal control;
determining whether the determination data satisfies a predetermined switching condition; and
switching the control mode of the traffic light at the intersection to the pedestrian-and-vehicle separating type signal control for a predetermined period of time in a case where it is determined that the determination data satisfies the predetermined switching condition.

### [Supplementary Note 15]

A computer-readable recording medium storing a program for causing a computer to execute a process including:
acquiring an operation schedule of a passenger-carrying vehicle at a station or a stop near an intersection;
creating, based on the operation schedule, a signal control schedule for switching a control mode of a traffic light at the intersection to a pedestrian-and-vehicle separating type signal control for a predetermined period of time; and
switching the control mode of the traffic light at the intersection based on the signal control schedule.

The forms of Supplementary Notes 12 to 15 can be expanded to the forms of Supplementary Notes 2 to 11, in addition to Supplementary Note 1.

It is to be noted that the disclosures of the above patent literature are incorporated herein by reference, and can be used as a basis or part of the present invention as necessary. Within the frame of the entire disclosure (including the claims) of the present invention, it is possible to change and adjust the example embodiments or examples further based on the basic technical idea. Various combinations or selections (including partial deletions) of various disclosure elements (including each element of each claim, each element of each example embodiment or example, each element of each drawing, and the like) can be made within the frame of the disclosure of the present invention. In other words, it is a matter of course that the present invention includes various modifications and corrections that can be made by those skilled in the art in accordance with the entire disclosure including the claims and the technical idea. In particular, for numerical ranges set forth herein, any numerical value or sub-range included within the range should be construed as being specifically described, even if not stated otherwise. Furthermore, it is also deemed that the matters disclosed in the literature cited above are included in the matters disclosed in the present application to use a part or all of the matters disclosed in the documents in combination with the matters described in the present specification as part of the disclosure of the present invention according to the gist of the present invention as necessary.

### REFERENCE SIGNS LIST

10, 10a, 100, 100a, 100b signal control system
11, 101 data acquisition means
12 signal control means
13 second data acquisition means
20 traffic light
201 operation schedule acquisition means
102 determination means
103 switching condition storage means
104, 204, 304 signal control means
105 display board control means
106 creation means
107 signal control schedule storage means
108 signal control mode notification means
140 camera
400 operation schedule database (operation schedule DB)
900 Information processing device
901 central processing unit (CPU)
902 read only memory (ROM)
903 random access memory (RAM)
904 program
905 storage device
906 recording medium
907 drive device
908 communication interface
909 communication network
910 input/output interface
911 bus
S1 vehicle traffic light
S2 pedestrian traffic light
D, D1, D2 display board

What is claimed is:

1. A signal control system comprising:
a memory; and
at least one processor coupled to the memory the at least one processor performing operations to:
acquire determination data for determining whether to switch a control mode of a traffic light at an intersection to a pedestrian-and-vehicle separating type signal control; and
switch the control mode of the traffic light at the intersection to the pedestrian-and-vehicle separating type signal control for a predetermined period of time in a case where it is determined that the current situation satisfies a predetermined switching condition based on the determination data.

2. The signal control system according to claim 1, wherein
the determination data is data indicating a position of a self-driving vehicle or a passenger-carrying vehicle, and
the at least one processor further performs operation to:
switch the control mode of the traffic light at the intersection to the pedestrian-and-vehicle separating type signal control for a predetermined period of time in a case where the self-driving vehicle or the passenger-carrying vehicle approaches the intersection.

3. The signal control system according to claim 2, wherein
the determination data is either a position notification from the self-driving vehicle or the passenger-carrying vehicle, or data transmitted from a sensor that detects entry of the self-driving vehicle or the passenger-carrying vehicle.

4. The signal control system according to claim 1, wherein
the determination data is an image of a vicinity of the intersection, and
the at least one processor further performs operation to:
switch the control mode of the traffic light at the intersection to the pedestrian-and-vehicle separating type signal control for a predetermined period of time based on the number or attributes of pedestrians appearing in the image.

5. The signal control system according to claim 1, wherein the at least one processor further performs operation to:
acquire an operation schedule of the passenger-carrying vehicle at a station or a stop near the intersection, wherein
switch the control mode of the traffic light at the intersection to the pedestrian-and-vehicle separating type signal control for a predetermined period of time based on the time information acquired as the determination data and the operation schedule information of the passenger-carrying vehicle.

6-8. (canceled)

9. The signal control system according to claim 1, wherein the at least one processor further performs operation to:
notify, to a vehicle near the intersection, the signal control mode being executed in the traffic light at the intersection.

10. The signal control system according to claim 9, wherein the at least one processor further performs operation to:
notify, to the vehicle, a counter or a figure indicating a waiting time until the next phase in the currently executed signal control mode.

11. The signal control system according to claim 1, wherein the at least one processor further performs operation to:
after switching from a signal control other than the pedestrian-and-vehicle separating type signal control to the pedestrian-and-vehicle separating type signal control, the signal control, for extending an all-red-light period in one cycle for a predetermined time, is performed.

12. A signal control method comprising:
acquiring determination data for determining whether to switch a control mode of a traffic light at an intersection to a pedestrian-and-vehicle separating type signal control;
determining whether a current situation satisfies a predetermined switching condition based on the determination data; and
switching the control mode of the traffic light at the intersection to the pedestrian-and-vehicle separating type signal control for a predetermined period of time in a case where it is determined that the determination data satisfies the predetermined switching condition.

13. (canceled)

14. A non-transitory computer-readable recording medium storing a program for causing a computer to execute a process comprising:
acquiring determination data for determining whether to switch a control mode of a traffic light at an intersection to a pedestrian-and-vehicle separating type signal control;
determining whether a current situation satisfies a predetermined switching condition based on the determination data; and
switching the control mode of the traffic light at the intersection to the pedestrian-and-vehicle separating type signal control for a predetermined period of time in a case where it is determined that the determination data satisfies the predetermined switching condition.

15. (canceled)
